(19) United States
(12) Patent Application Publication
(10) Pub. No.: US 2018/0309402 A1
(43) Pub. Date: Oct. 25, 2018

(54) MOTOR DRIVE DEVICE INCLUDING RESIDUAL CHARGE CONSUMPTION CONTROL UNIT

(71) Applicant: Fanuc Corporation, Minamitsuru-gun (JP)

(72) Inventor: Tomokazu Yoshida, Minamitsuru-gun (JP)

(73) Assignee: Fanuc Corporation, Minamitsuru-gun (JP)

(21) Appl. No.: 15/951,710

(22) Filed: Apr. 12, 2018

(30) Foreign Application Priority Data
Apr. 25, 2017 (JP) 2017-086306

(51) Int. Cl. H02P 27/06; H02M 5/458

(52) U.S. Cl. CPC H02P 27/06; H02M 5/458; B60L 2210/30; H02M 2001/322; B60L 2240/36; H02P 2201/03; B60L 2210/40

(57) ABSTRACT

A motor drive device includes a converter which converts an alternating current into a direct current and outputs the direct current to a DC link, a DC link capacitor, inverters, each of which is provided in correspondence with a motor, converts the direct current in the DC link into an alternating current, and outputs the alternating current to the corresponding motor, a temperature detection unit which detects the temperatures of the motors, an opening and closing unit which opens and closes an electrical path between the AC power supply and the converter, and a residual charge consumption control unit which controls at least one of the inverters to output a reactive current, in accordance with information concerning the motor temperatures detected by the temperature detection unit, when the opening and closing unit opens the electrical path to shut off AC input from the AC power supply to the converter.

### BACKGROUND OF THE INVENTION

### 1. Field of the Invention

The present invention relates to a motor drive device including a residual charge consumption control unit.

### 2. Description of the Related Art

In a motor drive device which drives motors mounted in a machine tool or a machine including, e.g., a robot, an alternating current input from an AC power supply is temporarily converted by a converter into a direct current, which is further converted by an inverter into an alternating current, whose power is used as drive power for a motor provided for each drive axis. Inverters are provided equal in number to, e.g., the motors to individually supply drive power to the motors provided in correspondence with the drive axes to perform drive control of the motors. Only one converter is generally provided for a plurality of inverters to reduce the cost and the footprint.

A DC link capacitor is provided in a DC link which connects the DC output of the converter to the DC input of each inverter. The DC link capacitor has the functions of storing DC power used to generate AC power by the inverter, and of suppressing the amount of pulsation of the DC output of the converter.

Generally, in a machine tool, when a motor drive device is disconnected from an AC power supply after the end of machining or upon the occurrence of an abnormality, residual charges stored in a DC link capacitor are desirably removed as early as possible to prevent the operator from receiving an electric shock. A press machine, for example, has a very large maximum power consumption upon its press operation and often poses a problem resulting from capacity shortage of power supply equipment in the AC power supply. Under the circumstances, in a motor drive device for a press machine, a DC link capacitor (also called a “capacitor bank”) which draws and stores power has a high capacitance, and when the press machine consumes power, the power is supplied from the DC link capacitor so that the power peak for the power supply equipment in the AC power supply may reduce. Since a high-capacitance DC link capacitor used for a press machine stores an enormous amount of energy and is especially dangerous, residual charges are desirably removed as soon as possible.

As a method for removing residual charges in the DC link capacitor after the motor drive device is disconnected from the AC power supply, the use of self-discharge, for example, is available. Generally, a motor drive device including a DC link capacitor includes an initial charge circuit for initially charging the DC link capacitor before the start of driving motors by the motor drive device, and a method for consuming residual charges in the DC link capacitor as thermal energy using a resistor (also called a “charge resistor”) in the initial charge circuit is also available. A method for consuming residual charges in the DC link capacitor as thermal energy using a discharge resistor in a separate charge circuit is even available.

As disclosed in, e.g., Japanese Unexamined Patent Publication (Kokai) No. 2013-038894, a charge circuit for a capacitor is known, which is applied to a system including a DC power supply, a power converter circuit that includes a pair of input terminals and is connected to the DC power supply via the pair of input terminals, a capacitor connected between the pair of input terminals of the power converter circuit, and a voltage detector circuit that detects a voltage across the pair of input terminals, and which includes a pair of electrical paths that connect the voltage detector circuit to the pair of input terminals, respectively, a series connector of resistors that is provided in the electrical paths and divides differences between potentials of the input terminals and a reference potential, a connection path that connects the pair of electrical paths to each other, an electronically-controlled opening and closing means, provided in the connection path, for opening and closing the connection path, and an operation means for performing an opening and closing operation of the opening and closing means, wherein the voltage detector circuit detects the voltage across the pair of input terminals based on the potential differences divided by the series connector of the resistors, and the connection path is connected between the pair of electrical paths to include at least one of the resistors in a closed-loop circuit including the capacitor and the connection path when the opening and closing means is set in a closed state by the operation means.

As disclosed in, e.g., Japanese Unexamined Patent Publication (Kokai) No. 2011-139620, an inverter control drive device is known, which includes inverters that are provided in correspondence with two general-purpose motors and perform drive control of the general-purpose motors, the inverters each including a converter unit that converts an AC voltage from an AC power supply into a DC voltage, a capacitor unit that smooths the voltage output from the converter unit, an output bridge unit that converts the DC voltage smoothed by the capacitor unit into a three-phase AC voltage and outputs the three-phase AC voltage to the general-purpose motor, an inrush current suppression resistance unit connected between the converter unit and the capacitor unit, a first switch connected in parallel with the inrush current suppression resistance unit, a second switch that parallelly connects the capacitor unit of one general-purpose motor of the general-purpose motors to the capacitor unit of the other general-purpose motor and is connected between the capacitor unit of the one general-purpose motor and the capacitor unit of the other general-purpose motor in the parallel circuit, and a third switch that connects a discharge resistor in parallel with a parallel circuit including the second switch and is connected to a parallel circuit including the discharge resistor, wherein the first switch changes from OFF to ON as a capacitor voltage of the capacitor unit of the general-purpose motor connected to the first switch reaches a first specified voltage, the second switch changes from OFF to ON as capacitor voltages of the capacitor units of the two general-purpose motors reach a second specified voltage higher than the first specified voltage and is kept ON, and the third switch changes from OFF to ON after the second switch changes from OFF to ON.

As disclosed in, e.g., Japanese Unexamined Patent Publication (Kokai) No. 2007-274867, a motor drive controller is known, which includes a drive means for driving a motor by supplying power from a power supply to the motor based on a deviation acquired by a deviation acquisition means during driving of the motor, and a regeneration means including a power regeneration means for regenerating energy generated by the motor to the power supply when a rotational speed of the motor is higher than a reference value during braking of the motor, and a heat regeneration means for converting energy generated by the motor into heat when the rotational speed of the motor is lower than the reference value.

When a motor drive device is disconnected from an AC power supply after the end of the operation of the motor drive device or upon the occurrence of an abnormality, residual charges in a DC link capacitor are desirably removed as early as possible to prevent the operator from receiving an electric shock.

A method for removing residual charges in the DC link capacitor by self-discharge involves a long time (e.g., several tens of minutes) to complete discharge, and has poor operation efficiency because the operator may not maintain the motor drive device and a machine including the motor drive device or deal with an abnormality during the discharge period. Especially in a press machine which uses a high-capacitance DC link capacitor, the time taken to complete discharge is very long and it is very dangerous for the operator to approach the DC link capacitor during the discharge period because of the high capacitance.

An initial charge circuit including a charge resistor and a switch connected in parallel with the charge resistor generally uses a low-cost thyristor exhibiting a self-extinction action as a switch. However, a method for consuming residual charges in the DC link capacitor as thermal energy by a resistor in the initial charge circuit may not use a switch exhibiting a self-extinction action and may preferably use a high-cost element exhibiting no self-extinction action such as an IGBT.

In a method for consuming residual charges in the DC link capacitor as thermal energy by a discharge resistor in the discharge circuit, a separate discharge circuit may be preferably provided, and this increases the size of the motor drive device and the cost.

### SUMMARY OF INVENTION

A motor drive device including a DC link capacitor demands a technique which can quickly, inexpensively remove residual charges in the DC link capacitor when the motor drive device is disconnected from an AC power supply.

In one aspect of the present disclosure, a motor drive device includes a converter which converts an alternating current input from an AC power supply into a direct current and outputs the direct current to a DC link, a DC link capacitor provided in the DC link, inverters, each of which is provided in correspondence with a motor, converts the direct current in the DC link into an alternating current, and outputs the alternating current to the corresponding motor, a temperature detection unit which detects temperatures of the motors, an opening and closing unit which opens and closes an electrical path between the AC power supply and the converter, and a residual charge consumption control unit which controls at least one of the inverters to output a reactive current, in accordance with information concerning the temperatures of the motors detected by the temperature detection unit, when the opening and closing unit opens the electrical path to shut off AC input from the AC power supply to the converter.

### BRIEF DESCRIPTION OF THE DRAWINGS

The present invention will be more clearly understood with reference to the following accompanying drawings:

FIG. 1 is a diagram illustrating a motor drive device according to a first embodiment;

FIG. 2 is a flowchart illustrating the operation sequence of the motor drive device illustrated in FIG. 1;

FIG. 3 is a diagram illustrating a motor drive device according to a second embodiment; and

FIG. 4 is a flowchart illustrating the operation sequence of the motor drive device illustrated in FIG. 3.

### DETAILED DESCRIPTION

A motor drive device including a residual charge consumption control unit will be described below with reference to the drawings. In the drawings, similar reference numerals denote similar members. The same reference numerals in different drawings denote components having the same functions. To facilitate an understanding, these drawings use different scales as appropriate.

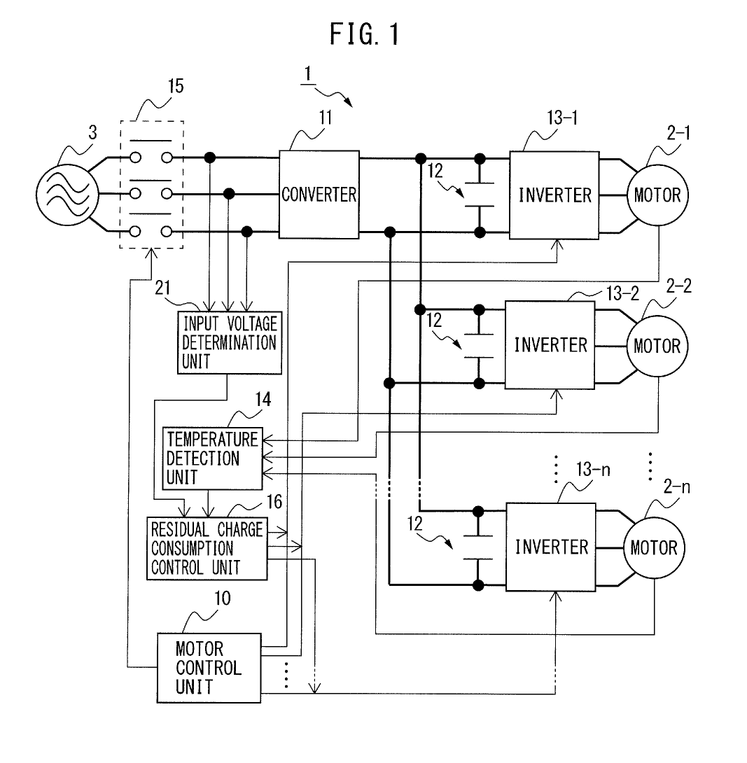

FIG. 1 is a diagram illustrating a motor drive device according to a first embodiment. Drive control of three-phase AC motors 2-n (n: positive integer) by a motor drive device 1 supplied with a three-phase alternating current from an AC power supply 3 will be taken as an example herein. The motor drive device 1 performs drive control of a motor provided for each drive axis in, e.g., a machine tool or a machine including, e.g., a robot. The type of motor 2-n does not particularly limit this embodiment, and an induction motor or a synchronous motor, for example, may be used. The numbers of phases of the AC power supply 3 and the motors 2 do not particularly limit this embodiment either, and a single-phase configuration, for example, may be used. In the example illustrated in FIG. 1, a three-phase configuration is used for the AC power supply 3, and three-phase AC motors are used as the motors 2-n.

Before a description of the motor drive device 1 according to the first embodiment, drive control for the motors 2-n will be described below. The motor drive device 1 includes a motor control unit 10 for controlling inverters 13-n (n: positive integer) which convert power between DC power in a DC link and AC power acting as drive power or regenerative power for the motors 2-n, like the general motor drive device. The motor control unit 10 generates a switching command for controlling the speeds, the torques, or the rotor positions of the motors 2-n, based on, e.g., the (rotor) speeds (speed feedback) of the motors 2-n, a current flowing through the windings of the motors 2-n (current feedback), a predetermined torque command, and an operation program for the motors 2-n. A power conversion operation by the inverters 13-n is controlled based on the switching command generated by the motor drive device 1. The configuration of the motor control unit 10 defined herein is merely an example, and the configuration of the motor control unit 10 may be defined including terms such as a position command generation unit, a torque command generation unit, and a switching command generation unit.

The motor drive device 1 according to the first embodiment includes the motor control unit 10, a converter 11, a DC link capacitor 12, the inverters 13-n, a temperature detection unit 14, an opening and closing unit 15, and a residual charge consumption control unit 16, as illustrated in FIG. 1.

The converter 11 converts an alternating current input from the AC power supply 3 into a direct current and outputs it to the DC link. Examples of the converter 11 may include a diode rectifier circuit, a 120-degree conduction rectifier circuit, and a PWM switching control rectifier circuit including a switching element. When the converter 11 serves as a diode rectifier circuit, an alternating current input from the AC power supply 3 is rectified and a direct current is output to the DC link on the DC side. When the converter 11 serves as a 120-degree conduction rectifier circuit or a PWM switching control rectifier circuit, it can be implemented as a bidirectional AC/DC-convertible power converter which converts AC power input from the AC power supply 3 into DC power and outputs it to the DC side, and during motor deceleration, converts DC power in the DC link into AC power and outputs it to the AC power supply 3. When the converter 11 serves as a PWM switching control rectifier circuit, it is implemented as a bridge circuit of a switching element and a diode connected in antiparallel with the switching element. In this case, examples of the switching element may include a unipolar transistor such as an FET, a bipolar transistor, an IGBT, a thyristor, and a GTO, but the type of switching element itself does not limit this embodiment, and other types of switching elements may be used.

A DC link capacitor 12 is provided in a DC link which connects the DC output of the converter 11 to the DC input of the inverter 13-n. The DC link capacitor 12 has the functions of storing DC power used to generate AC power by the inverter 13-n, and of suppressing the amount of pulsation of the DC output of the converter 11. In the example illustrated in FIG. 1, a DC link capacitor 12 is provided for each inverter 13-n, but only one DC link capacitor may be provided on the DC output side of the converter 11 and shared among the inverters 13-n. In this embodiment as well, an initial charge circuit for initially charging the DC link capacitors 12 before the start of driving each motor 2-n by the motor drive device 1 is provided, but it is not illustrated in FIG. 1.

Inverters 13-n are provided equal in number to, e.g., the motors 2-n (n inverters are provided in the example illustrated in FIG. 1) to individually supply drive power to the motors 2-n to perform drive control of the motors 2-n. The inverters 13-n are implemented as bridge circuits of switching elements and diodes connected in antiparallel with the switching elements, and ON/OFF control of each switching element is performed based on, e.g., the PWM switching control scheme. In this embodiment, since the motors 2-n connected to the motor drive device 1 are implemented as three-phase AC motors, the inverters 13-n are implemented as three-phase bridge circuits. Examples of each such switching element may include a unipolar transistor such as an FET, a bipolar transistor, an IGBT, a thyristor, and a GTO, but the type of switching element itself does not limit this embodiment, and other types of switching elements may be used.

The inverters 13-n are connected to the DC link, and ON/OFF control of each internal switching element is performed based on the switching command received from the motor control unit 10 to convert power between DC power in the DC link and AC power acting as drive power or regenerative power for the motors 2-n. More specifically, in the normal operation mode for the motors 2-n, the inverters 13-n perform a switching operation for the internal switching elements based on the switching command received from the motor control unit 10 to convert DC power (DC power stored in the DC link capacitors 12) supplied from the converter 11 via the DC link into AC power having a desired voltage and a desired frequency for driving the motors 2-n (inversion operation). Thus, the motors 2-n operate based on, e.g., variable-voltage, variable-frequency AC power. Although regenerative power may be generated during deceleration of the motors 2-n, a switching operation for the internal switching elements is performed based on the switching command received from the motor control unit 10 to convert the AC regenerative power generated by the motors 2-n into DC power and return it to the DC link (rectification operation). Although details will be described later, when the inverters 13-n receive a switching command for outputting a reactive current from the residual charge consumption control unit 16 or the motor control unit 10, they perform a switching operation for the internal switching elements based on the switching command for outputting a reactive current, to convert residual charges in the DC link capacitors 12 into a reactive current and output it.

The temperature detection unit 14 detects the temperatures of the motors 2-n. A temperature sensor (not illustrated) is attached to each motor 2-n and the temperature detection unit 14 collects information concerning the motor temperatures obtained by these temperature sensors. Each temperature sensor is preferably placed in a portion (e.g., an iron core or a winding) which generates a greatest amount of heat in the corresponding motor.

The opening and closing unit 15 opens and closes an electrical path between the AC power supply 3 and the converter 11 in response to an opening and closing command received from, e.g., the motor control unit 10 or its host controller (not illustrated). Examples of the opening and closing unit 15 may include an electromagnetic contactor and a relay. In the normal operation mode for the motors 2-n, as in the general motor drive device, when the operation of the motor drive device 1 is ended or an abnormality occurs in the motor drive device 1 and a machine including the motor drive device 1, the electrical path between the AC power supply 3 and the converter 11 is opened in response to an open command received from the motor control unit 10 to shut off AC power input from the AC power supply 3 to the converter 11. When the opening and closing unit 15 opens the electrical path to shut off AC input from the AC power supply 3 to the converter 11, residual charges have been stored in the DC link capacitors 12. These residual charges are removed from the DC link capacitors 12 by the processing of the residual charge consumption control unit 16.

The residual charge consumption control unit 16 controls at least one of the inverters 13-n to output a reactive current, in accordance with the motor temperatures detected by the temperature detection unit 14, when the opening and closing unit 15 opens the electrical path to shut off AC input from the AC power supply 3 to the converter 11. The circuit operation of the opening and closing unit 15 is controlled by the motor control unit 10. It is determined by, e.g., an input voltage determination unit 21 whether AC input from the AC power supply 3 to the converter 11 has been shut off. More specifically, the input voltage determination unit 21 monitors the input voltage on the AC input side of the converter 11 and determines that “AC input has been shut off” when this input voltage (interphase voltage) is nearly zero. When it is determined by the input voltage determination unit 21 that “AC input has been shut off,” the residual charge consumption control unit 16 starts reactive power control. As an alternative to this, when the motor control unit 10 sends an open command to the opening and closing unit 15, the residual charge consumption control unit 16 may determine that “AC input has been shut off” and start reactive power control. In this case, however, to ensure complete shut off of AC input from the AC power supply 3 to the converter 11, reactive power control by the residual charge consumption control unit 16 is preferably started a certain time after an open command is sent by the motor control unit 10.

Reactive current control by the residual charge consumption control unit 16 will be described in more detail herein.

An effective current which is output from the inverters 13-n and flows through the motors 2-n contributes to the occurrence of torque in the motors 2-n, i.e., the rotational operation of the motors 2-n. A reactive current which is output from the inverters 13-n and flows through the motors 2-n does not contribute to the occurrence of torque in the motors 2-n, and is only consumed as thermal energy by the resistors of windings in the motors 2-n without rotating the motors 2-n. Under the circumstances, in this embodiment, residual charges in the DC link capacitors 12 (i.e., DC power stored in the DC link capacitors 12) generated when the opening and closing unit 15 opens the electrical path to shut off AC input from the AC power supply 3 to the converter 11 are converted by the inverters 13-n into a reactive current, which is consumed as thermal energy by the motors connected to these inverters. Since the motors 2-n do not rotate even when a reactive current flows through them, residual charges in the DC link capacitors 12 can be safely removed.

The residual charge consumption control unit 16 controls the inverters 13-n to output a reactive current by, e.g., allowing the residual charge consumption control unit 16 itself to generate a switching command for outputting a reactive current. Alternatively, the residual charge consumption control unit 16 performs this control by instructing the motor control unit 10 to generate a switching command for outputting a reactive current, to cause the motor control unit 10 to generate the switching command in response to this instruction. In the example illustrated in FIG. 1, the residual charge consumption control unit 16 itself generates a switching command for outputting a reactive current. In response to the switching command for outputting a reactive current, the inverters 13-n perform a switching operation for the internal switching elements based on this switching command to convert residual charges in the DC link capacitors 12 into a reactive current and output it. The reactive current flows through the motors that are connected to these inverters and is consumed as thermal energy by these motors.

The residual charge consumption control unit 16 controls at least one of the inverters 13-n to output a reactive current. In this embodiment, an inverter controlled to output a reactive current by the residual charge consumption control unit 16 is selected from the inverters 13-n in accordance with the motor temperatures detected by the temperature detection unit 14. Several examples of inverter selection will be given hereinafter.

In the first mode of inverter selection, an inverter provided in correspondence with a motor having the lowest temperature among the temperatures of the motors 2-n detected by the temperature detection unit 14 is selected from the inverters 13-n. In other words, the residual charge consumption control unit 16 controls an inverter, provided in correspondence with a motor having the lowest temperature among the temperatures of the motors 2-n detected by the temperature detection unit 14, to output a reactive current when the opening and closing unit 15 opens the electrical path to shut off AC input from the AC power supply 3 to the converter 11. As a result, a reactive current flows through the motor having the lowest temperature and is consumed as thermal energy.

In the second mode of inverter selection, an inverter provided in correspondence with a motor having the lowest rate of temperature rise among the rates of temperature rise of the motors 2-n detected by the temperature detection unit 14 is selected from the inverters 13-n. More specifically, when the opening and closing unit 15 opens the electrical path to shut off AC input from the AC power supply 3 to the converter 11, the temperature detection unit 14 collects information concerning the temperature from the temperature sensor attached to each motor 2-n and calculates a rate of temperature rise per unit time for each motor 2-n. The residual charge consumption control unit 16 determines the lowest rate of temperature rise among the rates of temperature rise calculated for each motor 2-n and controls an inverter, provided in correspondence with a motor having the lowest rate of temperature rise, to output a reactive current. As a result, a reactive current flows through the motor having the lowest rate of temperature rise and is consumed as thermal energy.

An inverter provided in correspondence with a motor having the lowest temperature or the lowest rate of temperature rise among the temperatures is selected, as described above, to prevent breakdowns of the motor and the inverter due to heat generated as a reactive current flows through the motor.

The residual charge consumption control unit 16 may control at least two of the inverters 13-n to output a reactive current when the opening and closing unit 15 opens the electrical path to shut off AC input from the AC power supply 3 to the converter 11. When, for example, the residual charge consumption control unit 16 controls two inverters to output a reactive current, it controls a total of two inverters, respectively connected to a motor having the lowest temperature or the lowest rate of temperature rise and a motor having the second lowest temperature or rate of temperature rise to the motor having the lowest temperature, to output reactive power. In this manner, when at least two (i.e., a plurality of) inverters output reactive power, since a reactive current flows through at least two (i.e., a plurality of) motors 2 corresponding to these inverters, residual charges in the DC link capacitors 12 can be more quickly consumed.

Motors to be supplied with no reactive current may be defined in advance. In this case, the residual charge consumption control unit 16 controls at least one inverter other than “inverters connected to motors to be supplied with no reactive current” among the inverters 13-n to output a reactive current when the opening and closing unit 15 opens the electrical path to shut off AC input from the AC power supply 3 to the converter 11.

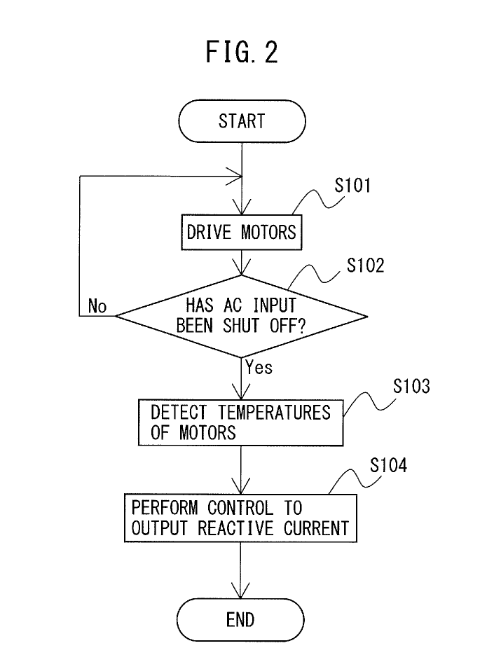

FIG. 2 is a flowchart illustrating the operation sequence of the motor drive device illustrated in FIG. 1.

In step S101 in which drive control of the motors 2-n is performed by the motor drive device 1, the motor control unit 10 generates a switching command for controlling the speeds, the torques, or the rotor positions of the motors 2-n, based on, e.g., the (rotor) speeds (speed feedback) of the motors 2-n, a current flowing through the windings of the motors 2-n (current feedback), a predetermined torque command, and an operation program for the motors 2-n. A power conversion operation by the inverters 13-n is controlled based on the switching command generated by the motor drive device 1. The inverters 13-n perform a switching operation for the internal switching elements based on the switching command received from the motor control unit 10 to convert DC power supplied from the converter 11 via the DC link into AC power having a desired voltage and a desired frequency for driving the motors 2-n (inversion operation). Thus, the motors 2-n operate based on, e.g., variable-voltage, variable-frequency AC power. When regenerative power is generated during deceleration of the motors 2-n, a switching operation for the internal switching elements is performed based on the switching command received from the motor control unit 10 to convert the AC regenerative power generated by the motors 2-n into DC power and return it to the DC link (rectification operation).

In step S102, the input voltage determination unit 21 determines whether AC input from the AC power supply 3 to the converter 11 has been shut off. As an alternative to this, the residual charge consumption control unit 16 determines whether AC input from the AC power supply 3 to the converter 11 has been shut off, based on whether an open command has been sent from the motor control unit 10 to the opening and closing unit 15. As described above, the opening and closing operation of the electrical path between the AC power supply 3 and the converter 11 by the opening and closing unit 15 is controlled by, e.g., the motor control unit 10 or its host controller. When the operation of the motor drive device 1 is ended or an abnormality occurs in the motor drive device 1 and a machine including the motor drive device 1, the opening and closing unit 15 receives an open command from the motor control unit 10 or its host controller to open the electrical path between the AC power supply 3 and the converter 11. Thus, AC input from the AC power supply 3 to the converter 11 is shut off. When it is determined in step S102 that AC input has been shut off, the process advances to step S103; otherwise, the process returns to step S101. When the opening and closing unit 15 opens the electrical path to shut off AC input from the AC power supply 3 to the converter 11, residual charges have been stored in the DC link capacitors 12.

In step S103, the temperature detection unit 14 detects the temperatures of the motors 2-n.

In step S104, the residual charge consumption control unit 16 controls at least one of the inverters 13-n to output a reactive current, in accordance with the motor temperatures detected by the temperature detection unit 14. The residual charge consumption control unit 16 selects an inverter provided in correspondence with a motor having the lowest temperature among the temperatures of the motors 2-n detected by the temperature detection unit 14 from the inverters 13-n. Alternatively, the residual charge consumption control unit 16 selects an inverter provided in correspondence with a motor having the lowest rate of temperature rise among the rates of temperature rise of the motors 2-n detected (calculated) by the temperature detection unit 14 from the inverters 13-n. The residual charge consumption control unit 16 controls the selected inverter to output a reactive current. The reactive current flows through the motor that are connected to this inverter and is consumed as thermal energy. Since the motor does not rotate even when reactive power flows through it, residual charges in the DC link capacitor 12 can be safely removed. The residual charge consumption control unit 16 may control at least two of the inverters 13-n to output a reactive current, in accordance with the motor temperatures detected by the temperature detection unit 14, as described above. The same operation sequence is applied both when a DC link capacitor 12 is provided for each inverter 13-n and when one DC link capacitor is provided on the DC output side of the converter 11 and shared among the inverters 13-n.

A second embodiment will be described next.

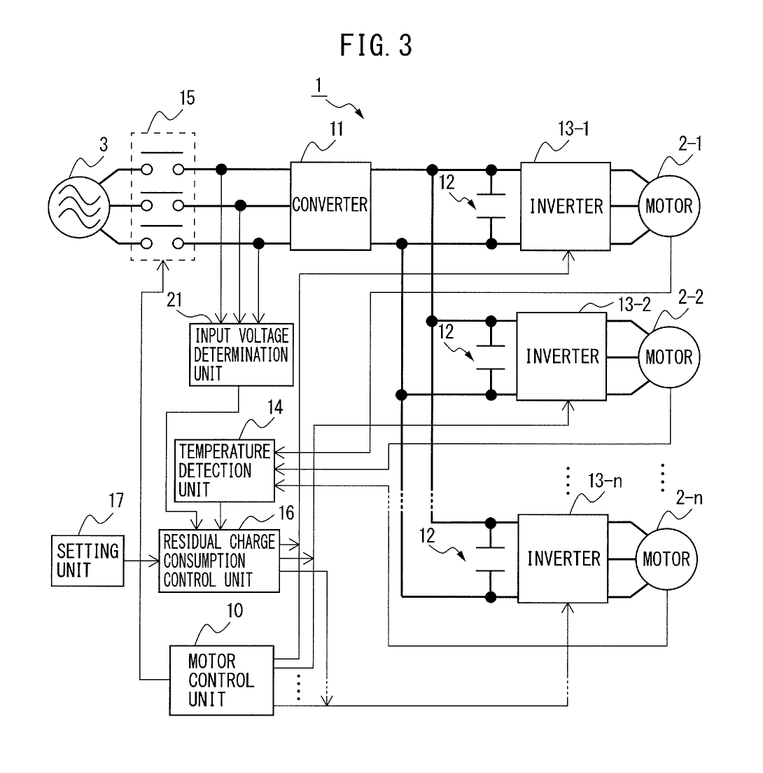

FIG. 3 is a diagram illustrating a motor drive device according to a second embodiment. In the second embodiment, the motor drive device 1 according to the first embodiment described with reference to FIGS. 1 and 2 further includes a setting unit 17 which sets a motor allowable temperature permitted for each motor 2-n.

The setting unit 17 includes a storage device which stores a motor allowable temperature for each motor 2-n, and an input device for inputting the motor allowable temperature to the storage device. The storage device is implemented as, e.g., an electrically erasable and programmable nonvolatile memory such as an EEPROM®, or a high-speed readable and writable random access memory such as a DRAM or an SRAM. The input device includes, e.g., a keyboard, a touch panel, a mouse, and a sound recognition device. The input device may be an independent input device, but it may be an accessory input device of a numerical controller (not illustrated) host to the motor drive device, a cell controller (not illustrated) host to the numerical controller, or a production management system (not illustrated) serving as a controller host to the cell controller. The storage device and the input device constituting the setting unit 17 may be connected to each other directly via known buses, or by known wireless or wired communication.

A motor allowable temperature defined as one of spec data in, e.g., a spec table or an instruction manual of motors or machines including the motors may be preferably used as, e.g., a maximum temperature permitted to exhibit the original performance of the motors. Generally, small motors have relatively low motor allowable temperatures, while large motors have relatively high motor allowable temperatures. Alternatively, a motor allowable temperature may be freely set by the operator in accordance with the environment to which the motors are applied or the application of the motors. For example, the motor allowable temperature can be set higher for motors equipped with coolers than for motors without no coolers.

The motor allowable temperature set in the setting unit 17 may be rewritable. For example, a motor allowable temperature defined as spec data in a spec table of motors may be set in the setting unit 17 and then changed to a desired motor allowable temperature by the operator, a motor allowable temperature freely set in the setting unit 17 by the operator may be changed at a later date to a motor allowable temperature defined as spec data in a spec table of motors, or the motor allowable temperature may be changed by the operator at regular or irregular intervals as appropriate.

When the temperature detected by a temperature detection unit 14 for a motor through which a reactive current output from a currently-controlled inverter 13-n flows is higher than the motor allowable temperature set for the motor in the setting unit 17, a residual charge consumption control unit 16 controls not this inverter (i.e., the inverter currently outputting a reactive current), but a different inverter to output a reactive current. The “different inverter” means herein an inverter connected to a motor having the second lowest temperature or the second lowest rate of temperature rise to the motor through which a reactive current output from the currently-controlled inverter 13-n flows. Although the residual charge consumption control unit 16 may control at least two of the inverters 13-n to output a reactive current, as already described in the first embodiment, it may control not the inverter currently outputting a reactive current, but only one or at least two (i.e., a plurality of) inverters to output a reactive current in the second embodiment as well.

Since circuit components other than the setting unit 17 and the residual charge consumption control unit 16 in the second embodiment are the same as those in the first embodiment illustrated in FIG. 1, the same reference numerals denote the same components, and a detailed description of these circuit components will not be given.

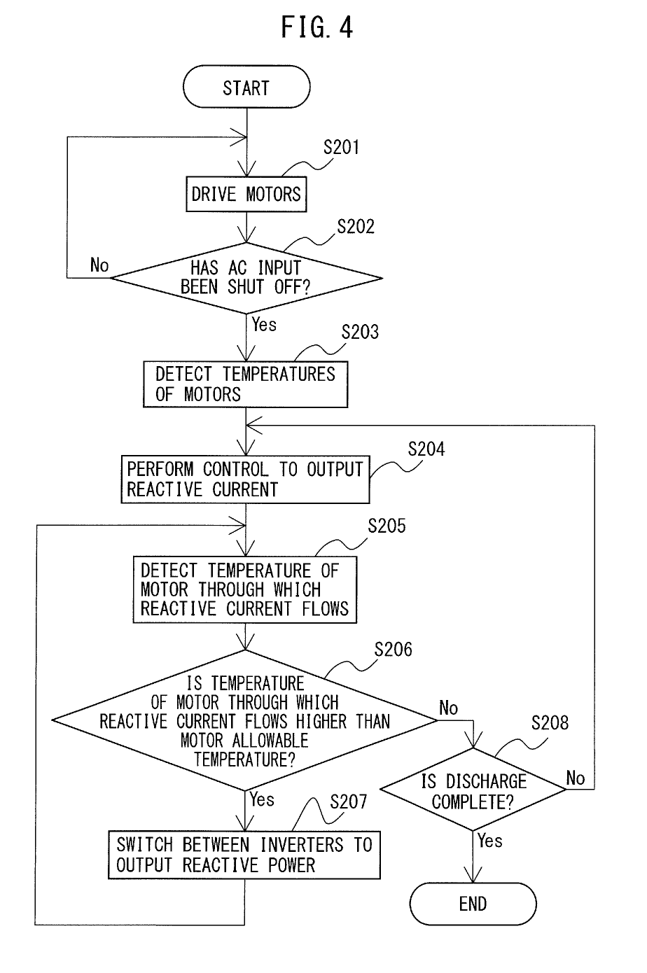

FIG. 4 is a flowchart illustrating the operation sequence of the motor drive device illustrated in FIG. 3.

In step S201, as in step S101 of the first embodiment, a motor control unit 10 generates a switching command for controlling the speeds, the torques, or the rotor positions of the motors 2-n, based on, e.g., the (rotor) speeds (speed feedback) of the motors 2-n, a current flowing through the windings of the motors 2-n (current feedback), a predetermined torque command, and an operation program for the motors 2-n. A power conversion operation by the inverters 13-n is controlled based on the switching command generated by the motor drive device 1. The inverters 13-n perform a switching operation for the internal switching elements based on the switching command received from the motor control unit 10 to convert DC power supplied from a converter 11 via a DC link into AC power having a desired voltage and a desired frequency for driving the motors 2-n (inversion operation). Thus, the motors 2-n operate based on, e.g., variable-voltage, variable-frequency AC power. When regenerative power is generated during deceleration of the motors 2-n, a switching operation for the internal switching elements is performed based on the switching command received from the motor control unit 10 to convert the AC regenerative power generated by the motors 2-n into DC power and return it to the DC link (rectification operation).

In step S202, the same operation as in step S102 of the first embodiment is performed, i.e., it is determined whether AC input from an AC power supply 3 to the converter 11 has been shut off. When it is determined in step S202 that AC input has been shut off, the process advances to step S203; otherwise, the process returns to step S201. When an opening and closing unit 15 opens the electrical path to shut off AC input from the AC power supply 3 to the converter 11, residual charges have been stored in DC link capacitors 12.

In step S203, the same operation as in step S103 of the first embodiment is performed, i.e., a temperature detection unit 14 detects the temperatures of the motors 2-n.

In step S204, the same operation as in step S104 of the first embodiment is performed, i.e., the residual charge consumption control unit 16 controls at least one of the inverters 13-n to output a reactive current, in accordance with the motor temperatures detected by the temperature detection unit 14.

In step S205, the temperature detection unit 14 detects the temperature of a motor 2-n through which a reactive current currently flows.

In step S206, the residual charge consumption control unit 16 determines whether the temperature detected by the temperature detection unit 14 for a motor through which a reactive current output from a currently-controlled inverter 13-n flows is higher than the motor allowable temperature set for the motor in the setting unit 17. When the temperature of the motor through which a reactive current flows is higher than the motor allowable temperature, the process advances to step S207; otherwise, the process advances to step S208.

In step S207, the residual charge consumption control unit 16 controls not the currently-controlled inverter (i.e., the inverter currently outputting a reactive current), but a different inverter to output a reactive current. The “different inverter” is as described above with reference to FIG. 3. After the process in step S207, the process returns to step S205.

When it is determined in step S206 that the temperature of the motor through which a reactive current flows is equal to or lower than the motor allowable temperature, the residual charge consumption control unit 16 determines in step S208 whether discharge of residual charges in the DC link capacitors 12 is complete. It may be preferably determined whether discharge of residual charges in the DC link capacitors 12 is complete, based on, e.g., the voltage across the two terminals of any DC link capacitor 12, and the residual charge consumption control unit 16 determines that discharge is complete when the voltage across the two terminals of this DC link capacitor 12 detected by a DC voltage detection unit (not illustrated) is nearly zero.

When it is determined in step S208 that discharge of residual charges in the DC link capacitors 12 is complete, the process ends. When it is determined in step S208 that discharge of residual charges in the DC link capacitors 12 is incomplete, the process returns to step S204. In other words, the processes in steps S204 to S208 are executed until discharge of residual charges in the DC link capacitors 12 is completed.

In this manner, with the motor drive device 1 according to the second embodiment, when the temperature detected by the temperature detection unit 14 for a motor through which a reactive current output from the currently-controlled inverter 13-n flows is higher than the motor allowable temperature, since not this inverter (i.e., the inverter currently outputting a reactive current), but a different inverter is controlled to output a reactive current, breakdowns of the motor and the inverter due to heat generation can be more reliably prevented.

The above-mentioned motor control unit 10, temperature detection unit 14, residual charge consumption control unit 16, and setting unit 17 may be constructed in the form of, e.g., a software program or constructed in a combination of various electronic circuits and a software program. When, for example, these units are constructed in the form of a software program, the functions of the above-mentioned respective units can be implemented by providing a computer for operating them in accordance with the software program, or by running the software program on an arithmetic processing unit in a numerical controller connected to the motor drive device 1. Alternatively, the motor control unit 10, the temperature detection unit 14, the residual charge consumption control unit 16, and the setting unit 17 may be implemented as a semiconductor integrated circuit into which a software program for implementing the function of each unit is written.

According to one aspect of the present disclosure, in a motor drive device including a DC link capacitor, residual charges in the DC link capacitor when the motor drive device is disconnected from an AC power supply can be removed quickly and inexpensively.

With a motor drive device according to one aspect of the present disclosure, residual charges generated in a DC link capacitor when an opening and closing unit opens the electrical path to shut off AC input from an AC power supply to a converter are converted by an inverter into a reactive current, which is consumed as thermal energy by a motor connected to the inverter, but since the motor does not rotate even when a reactive current flows through it, the residual charges in the DC link capacitor can be safely removed.

With the motor drive device according to another aspect of the present disclosure, a reactive current is supplied to an inverter provided in correspondence with a motor having the lowest temperature or the lowest rate of temperature rise among the temperatures of motors, breakdowns of the motor and the inverter due to heat generated as a reactive current flows through the motor can be prevented.

Since the motor drive device according to still another aspect of the present disclosure involves no additional circuit such as a discharge circuit to remove residual charges in the DC link capacitor, the cost is low.

In the motor drive device according to still another aspect of the present disclosure, since a reactive current flows through at least two (i.e., a plurality of) motors corresponding to at least two (i.e., a plurality of) inverters among a set of inverters as long as the reactive current is output to these inverters, residual charges in the DC link capacitor can be more quickly consumed.

1. A motor drive device comprising:
a converter which converts an alternating current input from an AC power supply into a direct current and outputs the direct current to a DC link;
a DC link capacitor provided in the DC link;
inverters, each of which is provided in correspondence with a motor, converts the direct current in the DC link into an alternating current, and outputs the alternating current to the corresponding motor;
a temperature detection unit which detects temperatures of the motors;
an opening and closing unit which opens and closes an electrical path between the AC power supply and the converter; and
a residual charge consumption control unit which controls at least one of the inverters to output a reactive current, in accordance with information concerning the temperatures of the motors detected by the temperature detection unit, when the opening and closing unit opens the electrical path to shut off AC input from the AC power supply to the converter.

2. The motor drive device according to claim 1, wherein the residual charge consumption control unit controls the inverter, provided in correspondence with a motor having a lowest temperature among the temperatures of the motors detected by the temperature detection unit, to output a reactive current when the opening and closing unit opens the electrical path to shut off AC input from the AC power supply to the converter.

3. The motor drive device according to claim 1, wherein the residual charge consumption control unit controls the inverter, provided in correspondence with a motor having a lowest rate of temperature rise among rates of temperature rise of the motors detected by the temperature detection unit, to output a reactive current when the opening and closing unit opens the electrical path to shut off AC input from the AC power supply to the converter.

4. The motor drive device according to claim 1, wherein the residual charge consumption control unit controls at least two of the inverters to output a reactive current when the opening and closing unit opens the electrical path to shut off AC input from the AC power supply to the converter.

5. The motor drive device according to claim 1, further comprising:
a setting unit which sets a motor allowable temperature permitted for each motor,
wherein when the temperature detected by the temperature detection unit for a motor through which a reactive current output from a currently-controlled inverter among the inverters flows is higher than the motor allowable temperature set for the motor in the setting unit, the residual charge consumption control unit controls not the currently-controlled inverter, but a different inverter among the inverters to output a reactive current.
